(19) United States
(12) Patent Application Publication
(10) Pub. No.: US 2016/0215919 A1
(43) Pub. Date: Jul. 28, 2016

(54) EXPANDABLE HOSE

(71) Applicant: Tzu-Lin HUANG, Xianxi Township (TW)

(72) Inventor: Tzu-Lin HUANG, Xianxi Township (TW)

(21) Appl. No.: 14/722,690

(22) Filed: May 27, 2015

(30) Foreign Application Priority Data
Jan. 28, 2015 (TW) 104201323

(51) Int. Cl. F16L 57/06; F16L 39/02; F16L 11/20

(52) U.S. Cl. CPC F16L 57/06; F16L 11/20; F16L 39/02

(57) ABSTRACT

An expandable house includes multiple flexible hoses and a connector provided to connect every two flexible hoses that longitudinally correspond to each other for forming a tubular structure. The tubular structure has two opposite ends each having a coupler longitudinally mounted thereon. The two couplers are respectively connected to a faucet and a water sprayer. Each flexible hose includes an inner tube and an outer tube sleeved on the inner tube, wherein the inner tube and the outer tube are synchronously longitudinally expanded to enhance the total length of the tubular structure due to a water pressure acted on an inner periphery of the inner tube. The tubular structure longitudinally shrinks to its original length for an easy storage when the water source is closed and the water pressure acted on the inner periphery of the inner tube is disappeared.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a hose, and more particularly to an expandable hose.

2. Description of Related Art Including Information Disclosed Under 37 CFR 1.97 and 37 CFR 1.98.

A flexible hose is a convenient tool to transmit water for washing car or gardening. However, a long hose is inconvenient for storage. As usual, the conventional flexible hose is rolled when being stored. However, the flexible hose may be twisted during rolling and the flexible hose may be cracked on the twisted portion.

Accordingly, a hose roller is marketed. However, the hose roller is not suitable to an ordinary family because the length of the hose for use at home usually does not extend over ten meters. The hose roller causes an excess quality to a flexible hose that is not long enough to full fill the hose roller.

In view of this, an expandable hose is available on the market. The expandable hose expands due to a water pressure therein. However, the conventional expandable hose in accordance with the prior art rubs the ground during expanding and shrinking. As a result, the conventional expandable hose is easily worn out and out of order due to a reciprocal friction.

The present invention has arisen to mitigate and/or obviate the disadvantages of the conventional flexible hoses.

### BRIEF SUMMARY OF THE INVENTION

The main objective of the present invention is to provide an improved expandable hose that includes at least one connector for preventing the expandable hose from being rubbed with the ground and worn out.

To achieve the objective, the expandable hose in accordance with the present invention comprises multiple flexible hoses and a connector provided to connect every two flexible hoses that longitudinally correspond to each other for forming a tubular structure. The tubular structure has two opposite ends each having a coupler longitudinally mounted thereon. The two couplers are respectively connected to a faucet and a water sprayer. Each flexible hose includes an inner tube and an outer tube sleeved on the inner tube, wherein the inner tube and the outer tube are synchronously longitudinally expanded to enhance the total length of the tubular structure due to a water pressure acted on an inner periphery of the inner tube. The tubular structure longitudinally shrinks to its original length for an easy storage when the water source is closed and the water pressure acted on the inner periphery of the inner tube is disappeared.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view of an expandable hose in accordance with the present invention;

FIG. 2 is a cross-sectional view of the expandable hose in FIG. 1;

FIG. 3 is a partially exploded cross-sectional view of the expandable hose in FIG. 1;

FIG. 4 is a partial cross-sectional view of the expandable hose in FIG. 1; and

FIG. 5 is a cross-sectional view of the expandable hose in accordance with the present invention after being expanded.

### DETAILED DESCRIPTION OF THE INVENTION

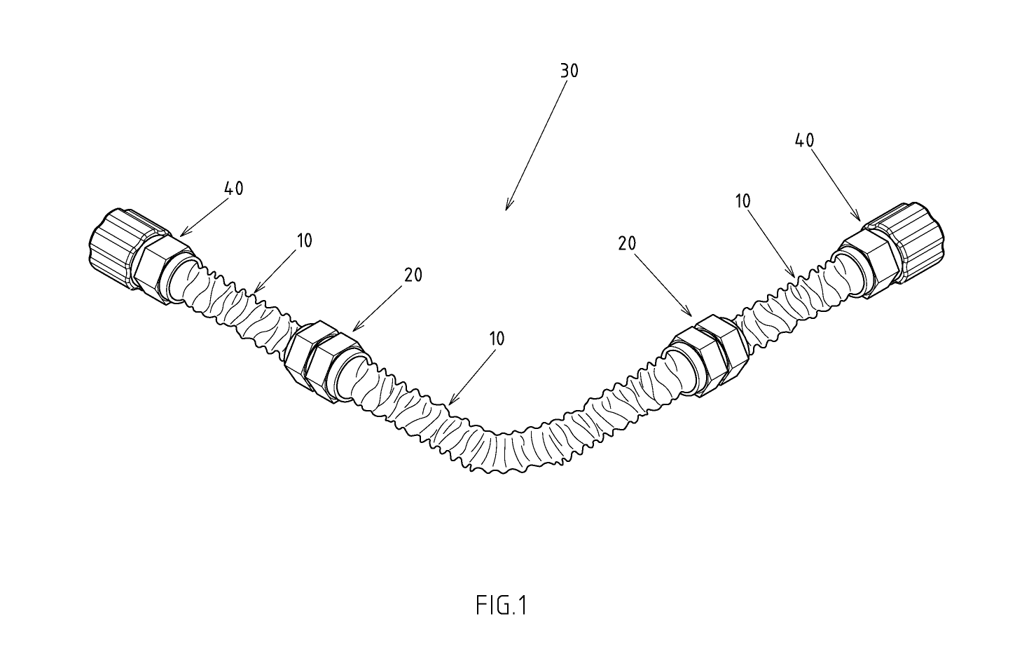

Referring to the drawings and initially to FIG. 1—, an expandable hose in accordance with the present invention comprises multiple flexible hoses 10 and a connector 20 provided to connect every two flexible hoses 10 that longitudinally correspond to each other for forming a tubular structure 30. The tubular structure 30 has two opposite ends each having a coupler 40 longitudinally mounted thereon. The two couplers 40 are respectively adapted to be connected to a faucet (not shown) or a water sprayer (not shown). Each flexible hose 10 includes an inner tube 11 and an outer tube 12 sleeved on the inner tube 11. The inner tube 11 and the outer tube 12 are synchronously longitudinally expanded to enhance the total length of the tubular structure 30 due to a water pressure acted on an inner periphery of the inner tube 11. The tubular structure 30 longitudinally shrinks to its original length for an easy storage when the water source is closed and the water pressure acted on the inner periphery of the inner tube is disappeared.

In the preferred embodiment of the present invention, the inner tube 11 and the outer tube 12 are not directly combined to each other. The distal ends of the inner tube 11 and the outer tube 12 securely radially abut each other by the connector 20 or the coupler 40. The inner tube 11 is expandable and the outer tube 12 is not expandable, but is pre-shrunk.

The connector 20 includes a stub 21 and two collar members 22 respectively mounted onto two opposite ends of the stub 21. The stub 21 has a through hole 211 centrally defined therein. Each end of the stub 21 has an annular groove 212 defined therein, wherein the annular groove 212 co-axially surrounds the through hole 211. The sleeved ends of the inner tube 11 and the outer tube 12 are inserted into a corresponding one of the annular grooves 212 and secured by the collar member 22. A tapered section 213 and a threaded section 214 are sequentially formed on one end of the stub 21. A tapered hole 221 and a threaded hole 222 are respectively defined in two opposite sides of the collar member 22, wherein the tapered hole 221 and the threaded hole 222 co-axially communicate with each other, and the tapered hole 221 in the collar member 22 complementally corresponds to the tapered section 213 on the stub 21.

The coupler 40 is a hollow structure and a through hole 411 centrally defined therein. The coupler 40 has a stub 41 centrally extending therefrom toward a corresponding one of the connectors 20, wherein a collar member 42 is mounted onto the stub 41 of the coupler 40. An annular groove 412 is centrally defined in a free end of the stub 41. A tapered section 413 and a threaded section 414 are sequentially formed on the stub 41. A tapered hole 421 and a threaded hole 422 are respectively defined in two opposite sides of the collar member 42, wherein the tapered hole 421 and the threaded hole 422 co-axially communicate with each other, and the tapered hole 421 in the collar member 42 complementally corresponds to the tapered section 413 on the stub 41. In the preferred embodiment of the present invention, the standards of the annular groove 212, tapered section 213 and the threaded section 214 of the connector 20 are the same as that of the annular groove 412, the tapered section 413 and the threaded section 414 of the coupler 40 for easily manufacturing and assembling the expandable hose in accordance with the present invention.

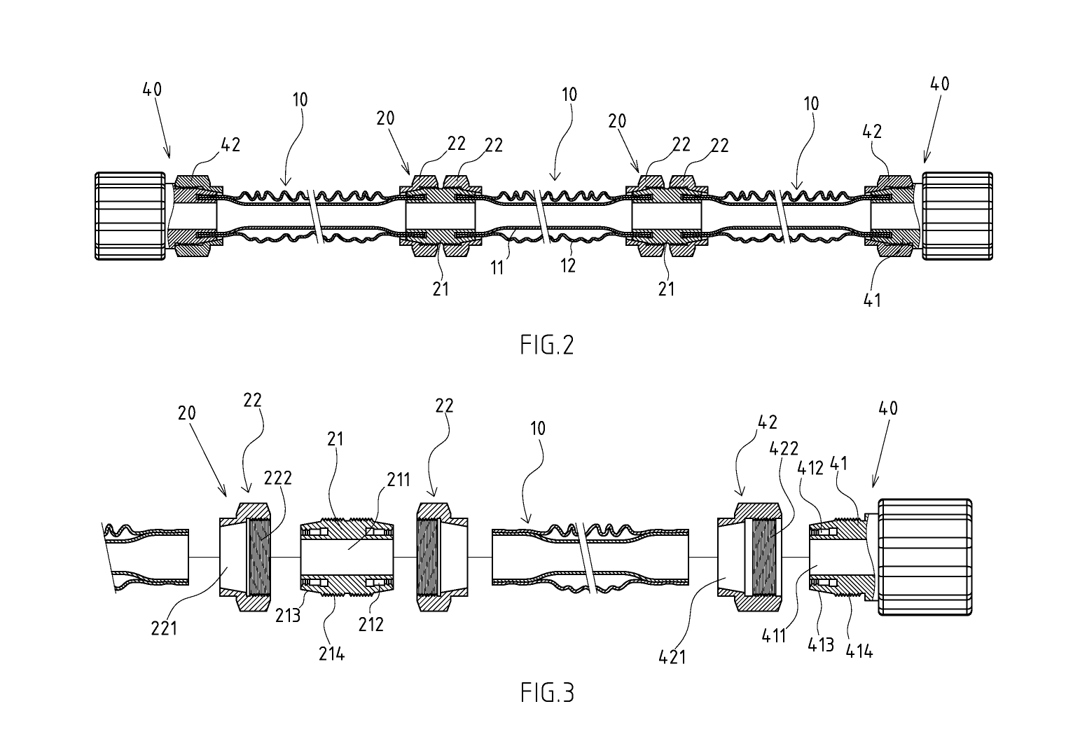

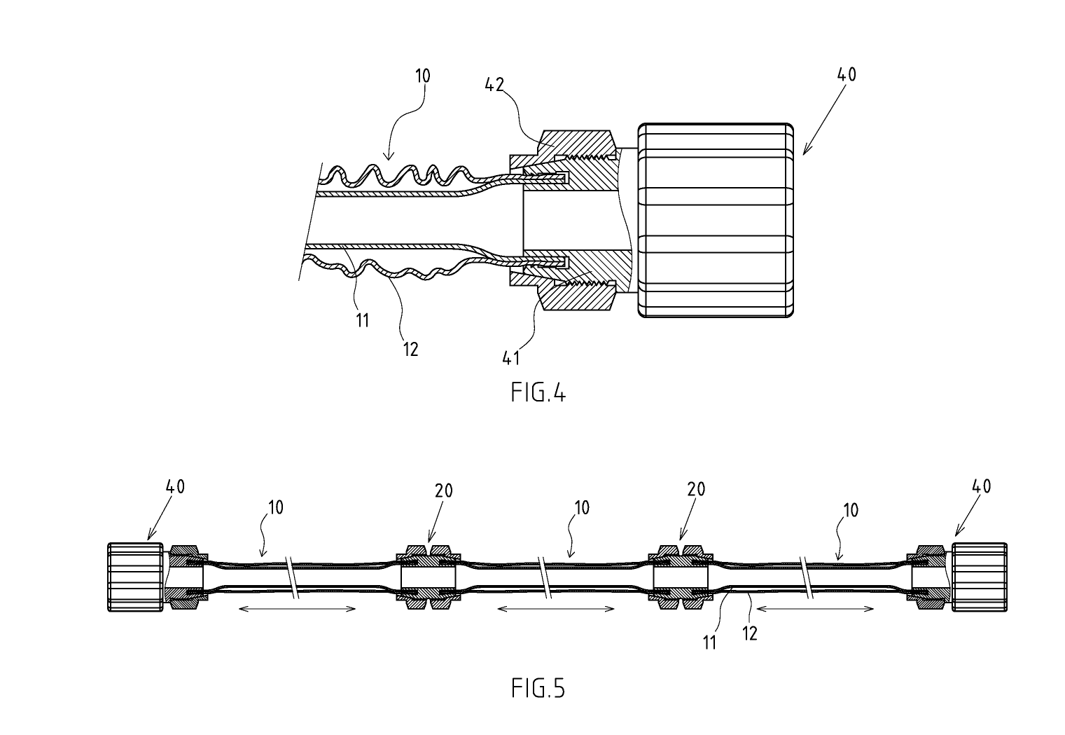

With reference to FIGS. 2, 3 and 4, when assembling the expandable hose in accordance with present invention, one end of the flexible hose 10 is inserted into the annular groove 212 of a corresponding stub 21 after extending through the tapered hole 221 and the threaded hole 222 of a corresponding collar member 22, and the corresponding collar member 22 is screwed onto the threaded section 214 of corresponding stub 21 to secure the flexible hose 10 and form the tubular structure 30. The tapered hole 221 of the collar member 22 gradually inwardly pushes the tapered section 213 of the stub 21 for narrowing the width of the annular groove 212 and airtightly clamping the end of the flexible hose 10 when screwing the collar member 22. Finally, two couplers 40 respectively mounted to two distal flexible 10 of the tubular structure 30, wherein the securing method of the stub 41 and the collar member 42 of the coupler 40 is the same as the stub 21 and the collar member 22 of the connector 20.

With reference to FIGS. 1, 2 and 5, the two couplers on two opposite ends of the tubular structure 30 is respectively connected to a water source (faucet) and a water sprayer. The water, with water pressure, flows into the tubular structure 30 after operating the faucet. The inner tube 11 longitudinally expands due to the water pressure that equally acts on the inner periphery of the inner tube 11, and the outer tube 12 expands with the inner tube 11 because the outer tube 12 is previously shrunk. Consequently, the total length of the tubular structure 30 is lengthened. The tubular structure 30 restores to its original length when the water source is closed and the water pressure is disappeared. The connector 20 can prevent the flexible hose 10 from being rubbed with the ground and worn out such that the flexible hose 10 has a long use life. In addition, the tubular structure 30 is formed by several sections of flexible hose 10 such that the user only needs to change the damaged section of flexible hose 10 and the repair cost is reduced.

The collar member 22/42 of the connector 20/coupler 40 can be replaced by a rolled hoop for reducing the manufacturing cost of the connector 20 and the coupler 40. In addition, the outer tube 12 also can be made of expandable material.

As described above, the expandable hose in accordance with the present invention includes the following advantages.
1. The expanding rate of the inner tube is related to the water pressure therein such that the tubular structure is restored to its original length for an easy storage when the water pressure in the inner tube disappears.
2. The connector can prevent the flexible hose from being rubbed with the ground and worn out such that the flexible hose has a long use life.
3. The flexible hoses can be changed section by section such that the repair cost of the expandable hose is reduced.
4. The standards of the annular groove, tapered section and the threaded section of the connector are the same as that of the annular groove, the tapered section and the threaded section of the coupler for easily manufacturing and assembling.

Although the invention has been explained in relation to its preferred embodiment, it is to be understood that many other possible modifications and variations can be made without departing from the spirit and scope of the invention as hereinafter claimed.

I claim:

1. An expandable hose comprising multiple flexible hoses and a connector provided to connect every two flexible hoses that longitudinally correspond to each other for forming a tubular structure, wherein the connector can prevent the flexible hose from being rubbed with the ground and worn out such that the flexible hose has a long use life, the tubular structure having two opposite ends each having a coupler longitudinally mounted thereon, the two couplers respectively adapted to be connected to a faucet and a water sprayer, each flexible hose including an inner tube and an outer tube sleeved on the inner tube, the inner tube and the outer tube synchronously longitudinally expanded to enhance the total length of the tubular structure due to a water pressure acted on an inner periphery of the inner tube, the tubular structure longitudinally shrinks to its original length for an easy storage when the water source is closed and the water pressure acted on the inner periphery of the inner tube is disappeared.

2. The expandable hose as claimed in claim 1, wherein the inner tube is expandable and the outer tube is pre-shrunk.

3. The expandable hose as claimed in claim 2, wherein the connector includes a stub and two collar members respectively mounted onto two opposite ends of the stub, the stub having a through hole centrally defined therein, each end of the stub having an annular groove defined therein, wherein the annular groove co-axially surrounds the through hole, the sleeved ends of the inner tube and the outer tube inserted into a corresponding one of the annular grooves and secured by the collar member, a tapered section and a threaded section sequentially formed on one end of the stub, a tapered hole and a threaded hole respectively defined in two opposite sides of the collar member, wherein the tapered hole and the threaded hole co-axially communicate with each other, and the tapered hole in the collar member complementally corresponds to the tapered section on the stub.

4. The expandable hose as claimed in claim 2, wherein the connector includes a stub and two collar members respectively mounted onto two opposite ends of the stub, the stub having a through hole centrally defined therein, each end of the stub having an annular groove defined therein, wherein the annular groove co-axially surrounds the through hole, the sleeved ends of the inner tube and the outer tube inserted into a corresponding one of the annular grooves and secured by the collar member, a tapered section and a threaded section sequentially formed on one end of the stub, a tapered hole and a threaded hole respectively defined in two opposite sides of the collar member, wherein the tapered hole and the threaded hole co-axially communicate with each other, and the tapered hole in the collar member complementally corresponds to the tapered section on the stub.

5. The expandable hose as claimed in claim 1, wherein the coupler is a hollow structure and includes a through hole centrally defined therein, the coupler having a stub centrally extending therefrom toward a corresponding one of the connectors, wherein a collar member is mounted onto the stub of the coupler, an annular groove centrally defined in a free end of the stub of the coupler, a tapered section and a threaded section sequentially formed on the stub of the coupler, a tapered hole and a threaded hole are respectively defined in two opposite sides of the collar member of the coupler, wherein the tapered hole and the threaded hole, in the coupler, co-axially communicate with each other, and the tapered hole in the collar member of the coupler complementally corresponds to the tapered section on the stub of the coupler.

6. The expandable hose as claimed in claim 2, wherein the coupler is a hollow structure and includes a through hole centrally defined therein, the coupler having a stub centrally extending therefrom toward a corresponding one of the connectors, wherein a collar member is mounted onto the stub of the coupler, an annular groove centrally defined in a free end of the stub of the coupler, a tapered section and a threaded section sequentially formed on the stub of the coupler, a tapered hole and a threaded hole are respectively defined in two opposite sides of the collar member of the coupler, wherein the tapered hole and the threaded hole, in the coupler, co-axially communicate with each other, and the tapered hole in the collar member of the coupler complementally corresponds to the tapered section on the stub of the coupler.

7. The expandable hose as claimed in claim 3, wherein the coupler is a hollow structure and includes a through hole centrally defined therein, the coupler having a stub centrally extending therefrom toward a corresponding one of the connectors, wherein a collar member is mounted onto the stub of the coupler, an annular groove centrally defined in a free end of the stub of the coupler, a tapered section and a threaded section sequentially formed on the stub of the coupler, a tapered hole and a threaded hole are respectively defined in two opposite sides of the collar member of the coupler, wherein the tapered hole and the threaded hole, in the coupler, co-axially communicate with each other, and the tapered hole in the collar member of the coupler complementally corresponds to the tapered section on the stub of the coupler.

8. The expandable hose as claimed in claim 4, wherein the coupler is a hollow structure and includes a through hole centrally defined therein, the coupler having a stub centrally extending therefrom toward a corresponding one of the connectors, wherein a collar member is mounted onto the stub of the coupler, an annular groove centrally defined in a free end of the stub of the coupler, a tapered section and a threaded section sequentially formed on the stub of the coupler, a tapered hole and a threaded hole are respectively defined in two opposite sides of the collar member of the coupler, wherein the tapered hole and the threaded hole, in the coupler, co-axially communicate with each other, and the tapered hole in the collar member of the coupler complementally corresponds to the tapered section on the stub of the coupler.

9. The expandable hose as claimed in claim 5, wherein the standards of the annular groove, tapered section and the threaded section of the connector are the same as that of the annular groove, the tapered section and the threaded section of the coupler for easily manufacturing and assembling the expandable hose.

10. The expandable hose as claimed in claim 6, wherein the standards of the annular groove, tapered section and the threaded section of the connector are the same as that of the annular groove, the tapered section and the threaded section of the coupler for easily manufacturing and assembling the expandable hose.

11. The expandable hose as claimed in claim 7, wherein the standards of the annular groove, tapered section and the threaded section of the connector are the same as that of the annular groove, the tapered section and the threaded section of the coupler for easily manufacturing and assembling the expandable hose.

12. The expandable hose as claimed in claim 8, wherein the standards of the annular groove, tapered section and the threaded section of the connector are the same as that of the annular groove, the tapered section and the threaded section of the coupler for easily manufacturing and assembling the expandable hose.
